(19) United States
(12) Patent Application Publication
(10) Pub. No.: US 2022/0203590 A1
(43) Pub. Date: Jun. 30, 2022

(54) MOLDING MACHINE AND METHOD FOR EXTRUDING MOLDED PRODUCT

(71) Applicant: TOYOTA JIDOSHA KABUSHIKI KAISHA, Toyota-shi (JP)

(72) Inventor: Yukio FUKUTA, Miyoshi-shi (JP)

(73) Assignee: TOYOTA JIDOSHA KABUSHIKI KAISHA, Toyota-shi (JP)

(21) Appl. No.: 17/521,223

(22) Filed: Nov. 8, 2021

(30) Foreign Application Priority Data
Dec. 24, 2020 (JP) 2020-214747

(51) Int. Cl. B29C 45/40; B29C 45/76

(52) U.S. Cl. CPC B29C 45/401; B29C 2945/76722; B29C 2945/76896; B29C 45/7626

(57) ABSTRACT

A molding machine includes: a mold that forms a molded product; an extrusion pin that transmits to the molded product an extrusion force for demolding the molded product from the mold, wherein the extrusion pin is inserted in the mold; and a control device configured to control the extrusion force of the extrusion pin. The control device controls the extrusion force at a first timing elapsed a first elapsed period so as to be greater than the extrusion force at second timing elapsed a second elapsed period. The first elapsed period is an elapsed period from a predetermined start point. The second period is an elapsed period from the start point and a shorter than the first elapsed period.

### CROSS REFERENCE TO RELATED APPLICATIONS

This application is based upon and claims benefit of priority from Japanese Patent Application No. 2020-214747, filed on Dec. 24, 2020, the entire contents of which are incorporated herein by reference.

### BACKGROUND

### Field

The present disclosure relates to a molding machine and a method for extruding a molded product.

### Related Art

There is known a diecasting machine which drives an electric servo motor at an output torque equal to or more than a rated torque only for a predetermined period until a molded product is demolded from a movable mold after extrusion pins start extruding the molded product, and drives the electric servo motor at a smaller output torque than the above output torque in other periods (see, for example, JP2010-12502A).

When the electric servo motor applies an excessive extrusion force to the extrusion pins, quality of the extrusion pins or the molded product lowers in some cases.

### SUMMARY

One aspect of the present disclosure provides a molding machine. This molding machine includes: a mold that forms a molded product; an extrusion pin that transmits to the molded product an extrusion force for demolding the molded product from the mold, wherein the extrusion pin is inserted in the mold; and a control device configured to control the extrusion force of the extrusion pin; wherein the control device controls the extrusion force at a first timing elapsed a first elapsed period so as to be greater than the extrusion force at second timing elapsed a second elapsed period, wherein the first elapsed period is an elapsed period from a predetermined start point, wherein the second period is an elapsed period from the start point and a shorter than the first elapsed period.

In a case where the elapsed period from the start point is long, the molding machine according to this aspect makes the extrusion force for demolding the molded product great compared to a case where the elapsed period is short. Consequently, it is possible to make the extrusion force great so as to correlate with an adhesion force of the molded product which is applied to the mold and which increases as the elapsed period becomes longer. Consequently, it is possible to prevent or reduce an excessive extrusion force from being applied to the extrusion pins or the molded product compared to a molding machine which extrudes a molded product using a fixed extrusion force irrespectively of the elapsed period.

### BRIEF DESCRIPTION OF THE DRAWINGS

FIG. 1 is an explanatory view illustrating a diecasting machine in a clamped state;

FIG. 2 is an explanatory view illustrating the diecasting machine in a mold opening state;

FIG. 3 is an explanatory view illustrating the diecasting machine in a state where a molded product is extruded;

FIG. 4 is a flowchart illustrating molded product extrusion control executed by a control device;

FIG. 5 is an explanatory view illustrating an example of a torque map; and

FIG. 6 is an explanatory view illustrating a torque map included in a diecasting machine according to a second embodiment.

### DETAILED DESCRIPTION

### A. First Embodiment

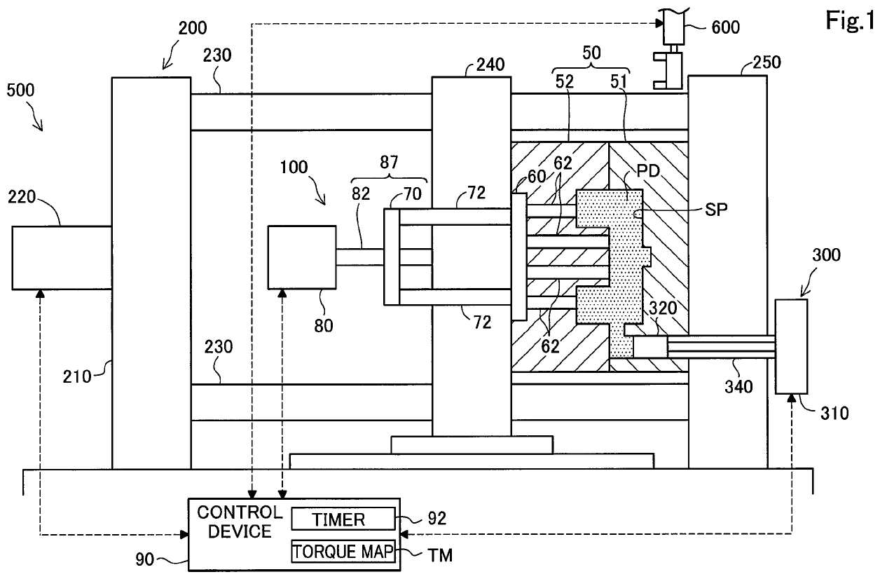

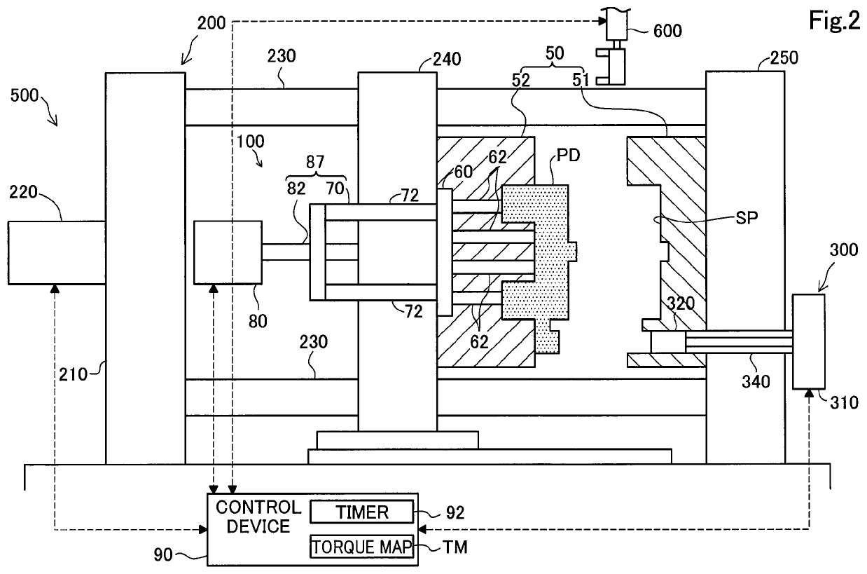

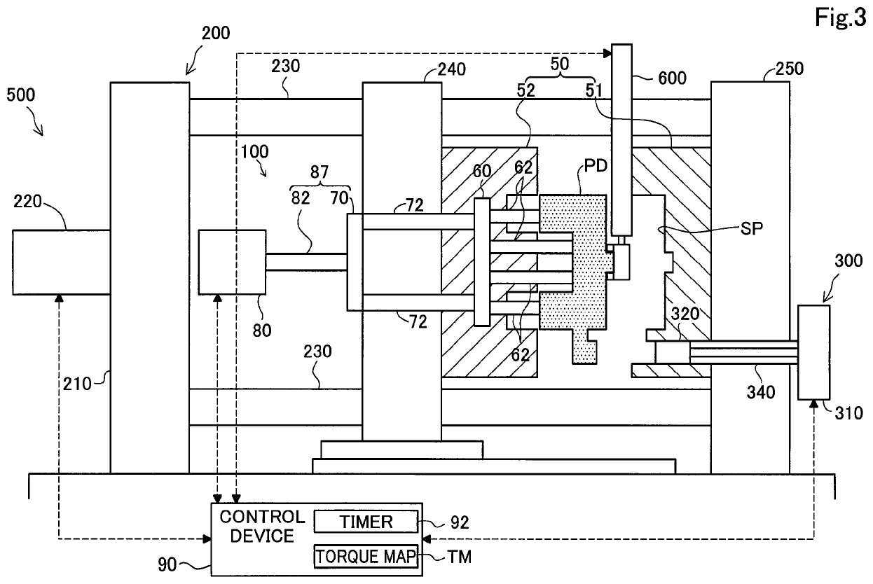

A configuration of a diecasting machine 500 according to the first embodiment of the present disclosure will be described with reference to FIGS. 1 to 3. FIG. 1 is an explanatory view illustrating the configuration of the diecasting machine 500 in a clamped state. FIG. 2 is an explanatory view illustrating the diecasting machine 500 according to a mold opening state. FIG. 3 is an explanatory view illustrating the diecasting machine 500 in a state where a molded product is extruded. The diecasting machine 500 is a molding machine which manufactures a molded product by injecting a molding machine in a space in a mold 50, and solidifying the molding material in the mold 50. The molding material is, for example, a pre-solidification metal material which is in a liquid or solid-liquid coexistence state. The pre-solidification metal material is also referred to as a molten metal. The metal material includes various materials such as aluminum, an aluminum alloy, a zinc alloy, a magnesium alloy and a copper alloy. The molding machine includes the diecasting machine 500 and, in addition, various molding machines such as an injection molding machine which uses a resin material as the molding material.

The mold 50 includes a fixed mold 51 and a movable mold 52. The mold 50 is used to form a molded product PD. The mold 50 may be direct machining or insert machining. The fixed mold 51 and the movable mold 52 may be combined with a core. The mold 50 may include a refrigerant flow path which circulates a refrigerant inside.

The diecasting machine 500 includes a clamping device 200, an injection device 300, an extrusion device 100 and a control device 90. The clamping device 200 opens/closes and clamps the mold 50 by using a driving force of a hydraulic cylinder 220 under control of the control device 90. Clamping the mold 50 means a process of pressurizing the mold 50 in a direction to close the mold 50 using a greater pressure than a pressure at a time of mold closing after the mold 50 is closed. In the present embodiment, the clamping device 200 includes a structure which is a combination of the hydraulic cylinder 220 and an unillustrated toggle mechanism. The clamping device 200 may be a direct pressure type which does not include a toggle mechanism, and uses a hydraulic cylinder.

The injection device 300 press-fits a pre-solidification metal material in the mold 50 under control of the control device 90. As illustrated in FIG. 1, a space SP of a substantially same shape as that of the molded product PD is formed in the mold 50 in the clamped state. The space SP is also referred to as a cavity. The injection device 300 injects and fills the pre-solidification metal material in the space SP.

The injection device 300 includes a sleeve 340 which continues to an interior of the mold 50, a plunger 320 which is slidable in the sleeve 340, and an injection driving unit 310 which drives the plunger 320. When the clamping device 200 finishes clamping the mold 50, an unillustrated supply device supplies a molding material of one shot into the sleeve 340 through an unillustrated supply port in an upper face of the sleeve 340. When the plunger 320 slides in the sleeve 340 toward the space SP, the molding material in the sleeve 340 is extruded into the mold 50. The pre-solidification molding material filled in the space SP is cooled and solidified when heat is absorbed by the mold 50. As a result, the molded product PD is formed.

The clamping device 200 includes a link housing 210, the hydraulic cylinder 220, tie bars 230, a movable die plate 240, and a fixed die plate 250. The fixed mold 51 is fixed to the fixed die plate 250. The movable mold 52 is fixed to the movable die plate 240. The movable die plate 240 faces the fixed die plate 250. The movable die plate 240 is movable in a direction to approach the fixed die plate 250, and a direction to move away from the fixed die plate 250 along the tie bars 230. By moving the movable die plate 240 using the driving force of the hydraulic cylinder 220, the clamping device 200 performs mold closing and mold opening for opening and closing the mold 50, and clamps the mold 50.

When the metal material injected in the space SP solidifies and the molded product PD is formed as illustrated in FIG. 2, the clamping device 200 moves the movable die plate 240 in a direction to move away from the fixed die plate 250 using the driving force of the hydraulic cylinder 220, and opens the mold 50.

As illustrated in FIG. 3, the extrusion device 100 extrudes the molded product from the movable mold 52 in the mold opening state. The extrusion device 100 includes extrusion pins 62 which extrude the molded product, an extrusion plate 60 which retains the extrusion pins 62, extrusion rods 72 which transmit extrusion forces to the extrusion plate 60, an extrusion driving unit 80, and a conversion mechanism 87.

The extrusion pin 62 is a shaft-shaped member. In the present embodiment, a plurality of extrusion pins 62 are provided. The extrusion pins 62 are inserted in the movable mold 52 such that an axial direction of the extrusion pins 62 faces along an opening/closing direction of the mold 50. Consequently, the extrusion pins 62 are movable in the movable mold 52 along the opening/closing direction of the mold 50. The number of the extrusion pins 62 may be one, and an appropriate number of the extrusion pins 62 may be provided at appropriate positions according to, for example, the shape of the interior of the mold 50 including the space SP.

The extrusion plate 60 is a plate-shaped member which fixes the extrusion pins 62. The extrusion plate 60 is housed in a space in the movable mold 52. A plurality of extrusion pins 62 move in the movable mold 52 along the opening/closing direction of the mold 50 as the extrusion plate 60 moves.

The extrusion pins 62 and the extrusion plate 60 can retreat to, for example, a position at which the extrusion plate 60 comes into contact with the movable die plate 240. To regulate a retreat position of the extrusion plate 60, the movable die plate 240 and the movable mold 52 may be provided with appropriate stopper members. When the extrusion plate 60 is arranged at the retreat position, distal end faces of the extrusion pins 62 match with an inner wall face of the movable mold 52.

The extrusion rods 72 are inserted in the movable die plate 240 such that the axial direction of the extrusion rods 72 faces along the opening/closing direction of the mold 50. Consequently, the extrusion rods 72 can move in the movable die plate 240 along the opening/closing direction of the mold 50. One ends of the extrusion rods 72 are fixed to the extrusion plate 60. By applying the driving force to the extrusion rods 72, it is possible to move the extrusion plate 60 and the extrusion pins 62 along the opening/closing direction of the mold 50. The number of extrusion rods 72 may be one or plural, and an appropriate number of the extrusion rods 72 may be provided at appropriate positions according to, for example, the shape and the size of extrusion plate 60.

The extrusion driving unit 80 applies an extrusion force for demolding the molded product from the movable mold 52, to the extrusion pins 62 under control of the control device 90. The extrusion driving unit 80 is an electric motor which includes a stator and a rotor which rotates against the stator. By controlling an unillustrated motor driver circuit and adjusting a supply amount of a drive current of a motor, the control device 90 can adjust an output torque of the extrusion driving unit 80. The extrusion driving unit 80 may include a plurality of electric motors, and adjust the output torque by using a plurality of electric motors. The extrusion device 100 may not include the motor driver circuit. In this case, by switching a tap of the motor of the extrusion driving unit 80 and adjusting a voltage, the control device 90 may directly adjust the output torque of the extrusion driving unit 80. In the present disclosure, that “the control device 90 controls the extrusion forces of the extrusion pins” is not limited only to a case where the control device 90 directly adjusts the extrusion forces of the extrusion pins 62, and includes a case where the control device 90 directly or indirectly controls the extrusion force such as a case where the control device 90 adjusts the output torque of the extrusion driving unit 80 which is necessary to obtain the extrusion forces of the extrusion pins 62.

The extrusion driving unit 80 is fixed to the movable die plate 240. The output torque of the extrusion driving unit 80 is transmitted to a screw shaft 82 as described below. The extrusion driving unit 80 may take various forms such as a direct current motor, an alternating current motor, a synchronous motor and an induction motor. An arrangement position and an orientation of the extrusion driving unit 80 may be set as appropriate.

The conversion mechanism 87 converts rotation transmitted from the extrusion driving unit 80 into a liner motion. The conversion mechanism 87 is formed by, for example, a screw mechanism. The screw mechanism may be a ball screw mechanism, or a slide screw mechanism. The conversion mechanism 87 includes the screw shaft 82, and a nut plate 70. The screw shaft 82 is supported rotatably axially in the movable die plate 240. The nut plate 70 is screwed to the screw shaft 82, and is regulated from rotating axially.

The extrusion rods 72 are fixed to the nut plate 70. A movement direction of the nut plate 70 in the conversion mechanism 87 is parallel to the axial direction of the extrusion rods 72, and is parallel to the opening/closing direction of the mold 50. When rotation of the extrusion driving unit 80 is transmitted to the screw shaft 82, the nut plate 70 moves along the axial direction of the screw shaft 82. When the nut plate 70 moves along the axial direction as illustrated in FIG. 3, the extrusion rods 72 move along the opening/closing direction of the mold 50, and the extrusion plate 60 fixed to the extrusion rods 72 moves along the opening/closing direction of the mold 50. When the extrusion plate 60 moves toward the mold 50, the extrusion pins 62 fixed to the extrusion plate 60 extrude the molded product from the movable mold 52 in the mold opening state.

FIG. 3 illustrates a state where the molded product PD demolded from the mold 50 by the extrusion device 100 is gripped by a convey device 600. The convey device 600 is a device which conveys the molded product PD to an outside of the diecasting machine 500, and carries the molded product PD to a subsequent process under control of the control device 90. The convey device 600 fixes the molded product PD by, for example, adsorbing or gripping the molded product PD. The convey device 600 detects that fixing the molded product PD has been finished using a measurement result of an adsorption pressure and a gripping force and a tactile sensor, and notifies the control device 90 of the detection result.

The convey device 600 conveys the fixed molded product PD to the outside of the diecasting machine 500, and carries the molded product PD to a subsequent process including, for example, a cooling process and a process of removing, for example, a runner from the molded product PD. After feeding the molded product PD to the subsequent process, the convey device 600 moves to a standby position near the diecasting machine 500 again to convey the molded product PD which is manufactured next. When, for example, an abnormality of the convey device 600 such as delay of feeding from the convey device 600 to the subsequent process occurs, the convey device 600 cannot move to the standby position or a position for accepting the molded product PD in the diecasting machine 500, or delays. In this case, the diecasting machine 500 stands by while the extrusion device 100 does not extrude the molded product PD in, for example, a state where the mold 50 is opened. As a result, an elapsed period in which the diecasting machine 500 forms the molded product PD becomes long compared to a normal time. “The elapsed period for forming the molded product PD” means a period from a time at which forming the one molded product PD using the diecasting machine 500 is started to a time at which this molded product PD is demolded from the mold 50.

As illustrated in FIGS. 1 to 3, the control device 90 is a microcomputer which includes a microprocessor which executes a logical operation, and a memory such as an ROM or an RAM. The microprocessor controls operations of the respective units of the extrusion device 100, the clamping device 200 and the injection device 300 of the diecasting machine 500 and the operation of the convey device 600 by executing programs stored in advance in the memory. Part or all of functions of the respective units of the convey device 600 and the diecasting machine 500 may be realized by hardware circuits.

According to the present embodiment, the control device 90 includes a torque map TM, and a timer 92 which counts the elapsed period. The timer 92 may be configured as one of hardware and software. In place of the timer 92, the control device 90 may obtain the elapsed period from a timer server.

The torque map TM is stored in advance in the memory of the control device 90. In the present embodiment, in the torque map TM, a correlation relationship between an elapsed period from a point of time which is a start point and at which filling the molding material in the mold 50 is finished, and an extrusion force which the extrusion driving unit 80 applies to the extrusion pins 62 is specified as described below. This correlation relationship between the elapsed period and the extrusion force is not limited only to the correlation relationship between the elapsed period and the extrusion force, and includes, for example, a correlation relationship between an item which directly or indirectly generates an extrusion force such as the output torque of the extrusion driving unit 80 which is necessary to obtain the extrusion forces of the extrusion pins 62, and an elapsed period. The control device 90 may determine an extrusion force by an arithmetic operation without including the torque map TM.

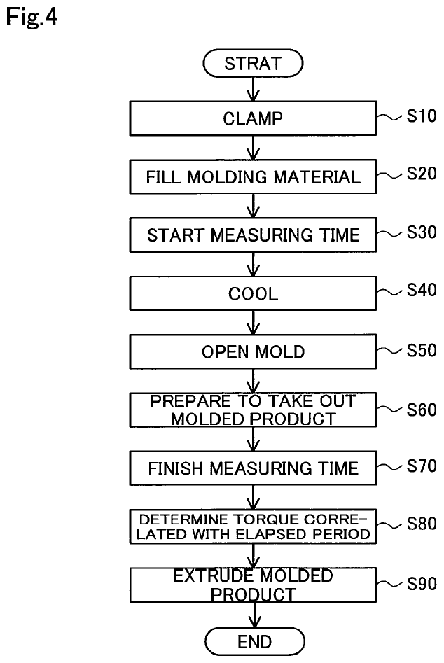

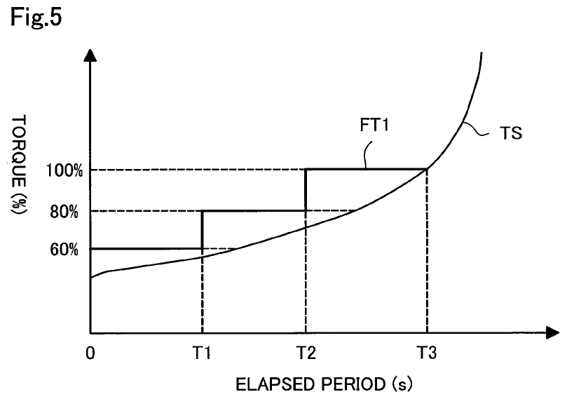

Molded product extrusion control executed by the control device 90 of the diecasting machine 500 according to the present embodiment will be described with reference to FIGS. 4 and 5. FIG. 4 is a flowchart illustrating molded product extrusion control executed by the control device 90. This flow is started at, for example, a point of time at which the clamping device 200 finishes closing the mold 50.

In step S10, the control device 90 controls the clamping device 200 to clamp the mold 50. The control device 90 drives the hydraulic cylinder 220 of the clamping device 200, applies a predetermined clamping force to the mold 50, and thereby executes clamping. In step S20, the control device 90 controls the injection device 300 to fill a pre-solidification molding material in the space SP in the mold 50 in the clamped state.

In step S30, the control device 90 causes the timer 92 to start measuring the time. A point of time at which the control device 90 starts time measurement for determining the output torque of the extrusion driving unit 80 is also referred to as a “start point”. To precisely determine the output torque of the extrusion driving unit 80, the start point is preferably at or after a point of time at which heat of the molding material starts being absorbed by the mold 50, and is preferably set at or after, for example, a timing at which the injection device 300 injects the molding material in the mold 50. According to the present embodiment, the start point is set at a point of time at which filling the molding material is finished. The point of time at which filling the molding material is finished is, for example, a point of time at which the plunger 320 reaches a push-in end position, or a point of time at which an inner pressure of an unillustrated injection cylinder included in the injection device 300 reaches a predetermined value corresponding to an end of filling. By using a limit switch, it is possible to detect that the plunger 320 has reached the push-in end position. By using a pressure sensor which detects the inner pressure of the injection cylinder, it is possible to detect that the inner pressure of the unillustrated injection cylinder included in the injection device 300 has reached the predetermined value corresponding to the end of filling. Furthermore, the point of time at which filing the molding material is finished may be other than these points of time, and may be specified by detecting various signals associated with timings of filling of the molding material. The start point may be set as the point of time at which filling the molding material is finished, and, in addition, for example, a point of time at which filling the molding material is started, a point of time at which cooling the molding material is started, a point of time at which cooling the molding material is finished, a point of time at which opening the mold 50 is started, or a point of time at which opening the mold 50 is finished, and may be set at an arbitrary timing while these processes are executed. The start point may be set by using a temperature of the molding material or a change amount of the temperature obtained by the mold 50 or a temperature sensor included in the mold 50.

In step S40, the control device 90 cools the molding material. More specifically, by retaining the mold 50 in the clamped state until a cooling period set in advance passes from the start point, the control device 90 cools the molding material. The cooling period can be set by using a time such as several tens of seconds for sufficiently solidifying the molding material. The cooling period may be arbitrarily set according to a size, a shape or a molding material of the molded product PD and a material of a mold.

In step S50, the control device 90 opens the mold 50. More specifically, the control device 90 drives the hydraulic cylinder 220, moves the movable die plate 240 in a direction to move away from the fixed die plate 250, and thereby opens the mold 50. In step S60, the control device 90 prepares to take out the molded product PD. According to the present embodiment, the control device 90 drives the convey device 600, fixes to the convey device 600 the molded product PD adhered to the movable mold 52, and thereby finishes takeout preparation.

In step S70, the control device 90 finishes measuring the time from the start point. In the present embodiment, the control device 90 finishes measuring the time at a point of time at which step S60 is finished and takeout preparation of the molded product PD is finished. By receiving a notification that, for example, fixing the molded product PD fed by the convey device 600 has been finished, the control device 90 recognizes that the takeout preparation of the molded product PD has been finished. The timing to finish time measurement may be set as a point of time at which the takeout preparation of the molded product PD is finished, and, in addition, for example, a point of time at which cooling the molding material is finished, a point of time at which opening the mold 50 is started, or a point of time at which opening the mold 50 is finished, and may be set at an arbitrary timing while these processes are executed. The timing to finish time measurement may be set by using a temperature of the molding material or a change amount of the temperature obtained by the mold 50 or a temperature sensor included in the mold 50.

In step S80, the control device 90 determines the extrusion force correlated with the elapsed period from the measured start point. In the present embodiment, the control device 90 determines the output torque of the extrusion driving unit 80 which is necessary to obtain the extrusion force correlated with the elapsed period by using the torque map TM stored in the memory. In step S90, the extrusion driving unit 80 drives the extrusion driving unit 80 using the determined torque. According to the present embodiment, by adjusting a supply amount of a drive current to the motor of the extrusion driving unit 80 under control of the unillustrated motor driver circuit, the control device 90 adjusts the output torque of the extrusion driving unit 80. As a result, the molded product PD adhered to the movable mold 52 is extruded by the extrusion pins 62, and demolded. When extruding the molded product PD is finished, this flow is finished. The convey device 600 conveys the fixed molded product PD to a subsequent process.

A method which determines the output torque of the extrusion driving unit 80 and is executed by the control device 90 in step S80 will be described with reference to FIG. 5. FIG. 5 is an explanatory view illustrating one example of the torque map TM stored in the memory of the control device 90. In the torque map TM, a correlation relationship between an elapsed period from a start point at which filling the molding material in the mold 50 is finished, and the output torque of the extrusion driving unit 80 is specified as indicated by a solid line FT1 in FIG. 5.

As illustrated in FIG. 5, in a case where, for example, an elapsed period T2 passes from the start point, the output torque of the extrusion driving unit 80 is great compared to a case where an elapsed period T1 shorter than the elapsed period T2 passes from the start point. Similarly, in a case where, for example, an elapsed period T3 passes from the start point, the output torque of the extrusion driving unit 80 is great compared to a case where the elapsed period T1 or the elapsed period T2 passes from the start point. In other words, when the elapsed period from the start point is long, the output torque of the extrusion driving unit 80 is set to become great compared to a case where the elapsed period is short. In the present disclosure, when an elapsed period from the start point is a “first elapsed period”, an elapsed period shorter than the first elapsed period is also referred to as a “second elapsed period”. In the example in FIG. 5, when the elapsed period T2 is the first elapsed period, the elapsed period T1 is the second elapsed period. When the elapsed period T3 is the first elapsed period, at least one of the elapsed period T1 and the elapsed period T2 corresponds to the second elapsed period. The elapsed period from the start point varies due to, for example, delay of an acceptance timing of the molded product PD caused by an abnormality of the convey device 600 which accepts the molded product PD, or emergency stop at a time of cooling of the molded product PD caused by an abnormality of the diecasting machine 500. That “in a case where the elapsed period from the start point is long, the output torque is great compared to a case where the elapsed period is short” means that the output torque macroscopically becomes greater as the elapsed period becomes longer, and includes a case where, for example, the output torque temporarily decreases in a slight period included in the elapsed period, and the output torque after the temporary decrease occurs is greater than the output torque before the temporary decrease occurs.

In FIG. 5, a correlation relationship between the elapsed period and an adhesion force of the molded product PD with respect to the movable mold 52 is conceptually indicated as a curve TS to make it easy to understand the technique. The molding material thermally contracts due to cooling at a time of solidification, and adheres to the movable mold 52. Hence, to demold the molded product PD from the movable mold 52, it is necessary to apply a greater extrusion force than the adhesion force of the molded product PD with respect to the movable mold 52. The inventors of the present invention have found that, as indicated by the curve TS, as the cooling period of the molded product PD is longer, a thermal contraction amount of the molded product PD becomes larger, and the adhesion force with respect to the movable mold 52 becomes greater. The extrusion force which is necessary to demold the molded product PD from the movable mold 52 becomes greater as the cooling period of the molded product PD becomes longer as indicated by the curve TS. In the torque map TM, as indicated by the solid line FT1, the output torque per elapsed period from the start point takes as an upper limit a maximum value of a torque which the extrusion driving unit 80 can output, and is set to become equal to or more than the adhesion force with respect to the movable mold 52 as indicated by the curve TS. The output torque per elapsed period indicated by the solid line FT1 can be experimentally calculated by measuring per elapsed period from the start point the output torque of the extrusion driving unit 80 which can obtain the extrusion force which can demold the molded product PD.

In the present embodiment, the output torque of the extrusion driving unit 80 is further set to become greater in a stepwise manner as the elapsed period from the start point becomes longer. More specifically, when the maximum value of the torque which the extrusion driving unit 80 can output is 100%, the output torque of the extrusion driving unit 80 is set to 60% by the elapsed period T1 from the start point. The output torque is set to 80% from the elapsed period T1 to the elapsed period T2, and the output torque is set to 100% from the elapsed period T2 to the elapsed period T3. In the present embodiment, the output torque is set at three levels per 20% in a range where a minimum value is 60% and the maximum value is 100%. However, the output torque may be set to become greater in a stepwise manner at a plurality of levels such as two levels or four levels or more. The minimum value of the output torque is not limited to 60%, and may be 10% or 20%, or may be set to an arbitrary numerical value such as 50% or 75%. The maximum value of the output torque is not limited to 100%, and may be 90% or 75%, or may be set to an arbitrary numerical value such as 50% or 25%.

In the present embodiment, the extrusion force obtained from a 100% output torque is set to approximately several tens of tons. In this regard, the diecasting machine which can obtain the extrusion force using the hydraulic cylinder does not adjust the extrusion force in a stepwise manner, and sets the extrusion force only to the maximum value at which the molded product PD can be demolded irrespectively of the elapsed period from the start point. The extrusion force which the diecasting machine 500 according to the present embodiment can obtain from the 100% output torque of the extrusion driving unit 80 is preferably set smaller than the extrusion force set by the diecasting machine which obtains the extrusion force using this hydraulic cylinder from a viewpoint to improvement productivity, and is preferably, for example, less than 80 tons.

When the elapsed period exceeds the elapsed period T3, the adhesion force of the molded product PD becomes greater than the extrusion force which can be obtained by the extrusion driving unit 80, and cannot demold the molded product PD. At a point of time at which the elapsed period to be measured reaches the elapsed period T3 or before the elapsed period reaches the elapsed period T3, the control device 90 may notify a user or an administrator of the diecasting machine 500 of an abnormality.

As described above, in a case where the elapsed period from the start point is long, the diecasting machine 500 according to the present embodiment sets the output torque of the extrusion driving unit 80 to become great compared to a case where the elapsed period is short. The diecasting machine 500 according to the present embodiment adjusts the output torque of the extrusion driving unit 80 such that the extrusion force of the molded product PD becomes great so as to correlate with the adhesion force which increases as the elapsed period for forming the molded product PD becomes longer. Hence, in a case where, for example, the elapsed period from the start point is short and the adhesion force of the molded product PD with respect to the mold 50 is little, it is possible to reduce the output torque of the extrusion driving unit 80 compared to a case where the molded product PD is demolded by a fixed extrusion force irrespectively of the elapsed period. Consequently, it is possible to reduce or prevent an excessive extrusion force from being applied to the extrusion pins 62 or the molded product PD, and reduce or prevent quality of each unit of the extrusion device 100 or quality of the molded product PD from lowering. By reducing the output torque, it is possible to reduce power consumption of the extrusion driving unit 80.

The diecasting machine 500 according to the present embodiment sets the elapsed period measured by the control device 900 as a period to a point of time at which the molded product PD is fixed to the convey device 600. Consequently, it is possible to set an appropriate output torque for a variation of the adhesion force caused by a variation of the cooling period of the molded product PD which occurs due to an abnormality of the convey device 600.

The diecasting machine 500 according to the present embodiment sets the start point of the elapsed period at a point of time at which filling the molding material in the mold 50 is finished. By setting the point of time at which filling the molding material is finished as the start point, the control device 90 can easily measure the time. Furthermore, by setting the point of time at which filling the molding material is finished as the start point, and setting a point of time at which the molding material for forming the molded product PD is filled, that is, a timing at which cooling the molded product PD is started as the start point, it is possible to reduce an influence of the variation of the cooling period, and precisely determine the output torque of the extrusion driving unit 80.

According to the diecasting machine 500 according to the present embodiment, the control device 90 drives the extrusion driving unit 80 to make the extrusion force greater in a stepwise manner as the elapsed period becomes longer. By adjusting the output torque of the extrusion driving unit 80 in the stepwise manner, it is possible to reduce a processing burden of the control device 90 compared to a case where the output torque is adjusted in a non-stepwise manner.

The diecasting machine 500 according to the present embodiment includes the torque map TM which specifies the correlation relationship between the elapsed period from a point of time at which filling the molding material in the mold 50 is finished, and the extrusion force which the extrusion driving unit 80 applies to the extrusion pins 62. Consequently, it is possible to reduce the processing burden of the control device 90 compared to a case where the extrusion force is determined by the arithmetic operation.

### B. Second Embodiment

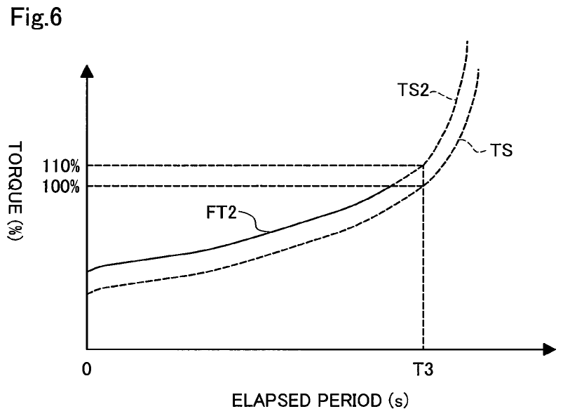

FIG. 6 is an explanatory view illustrating the torque map TM included in the diecasting machine 500 according to the second embodiment of the present disclosure. In the present embodiment, as indicated by a solid line FT2 in FIG. 6, the torque map TM specifies a correlation relationship between the elapsed period from the start point at which filling the molding material in the mold 50 is finished, and the output torque of the extrusion driving unit 80. The curve TS illustrated as a broken line may be the same as the curve TS which indicates the torque map TM according to the first embodiment illustrated in FIG. 5.

FIG. 6 illustrates the curve TS2 as the broken line. The curve TS2 is a curve obtained by adding to the curve TS a correction value based on a surface area of the inner wall of the movable mold 52 which forms the space SP. The adhesion force of the molding material with respect to the mold 50 becomes greater as the contact area of the molding material and the mold 50 becomes larger. According to the present embodiment, the curve TS2 can be obtained by multiplying a ratio of an area of an inner surface of the mold 50 to be actually used with respect to an area of an inner surface of the mold 50 used to empirically obtain the curve TS, that is, for example, 1.1 times on the curve TS. By employing this configuration, it is not necessary to empirically generate the torque map TM per type of the molded product PD.

The curve TS2 only needs to be set to cause the extrusion pins 62 to operate using great extrusion forces in a case where the contact area of the mold 50 and the molding material is large compared to a case where the contact area is small. The curve TS2 may be obtained by multiplying the ratio of the extrusion force on the curve TS. The curve TS2 may be calculated by using various factors such as the shape of the space SP such as protrusions and recesses of the inner surface of the mold or an application amount of a mold release agent which influences the adhesion force of the molding material and the mold 50. In addition, whether or not the extrusion pins 62 are set to operate using great extrusion forces in a case where the contact area is large compared to a case where the contact area is small can be verified by using the two diecasting machines 500. More specifically, when an elapsed period from the start points of the two diecasting machines 500 to start of extrusion, if the extrusion force of the diecasting machine 500 which is demolding the mold 50 having the large contact area is greater, it is possible to verify that the extrusion pins 62 are caused to operate using the great extrusion forces compared to the case where the contact area is small.

According to the present embodiment, the output torque of the extrusion driving unit 80 is set to become greater along the curve TS2. In other words, according to the present embodiment, the output torque of the extrusion driving unit 80 is set to become greater in a non-stepwise manner as the elapsed period from the start point becomes longer. By employing this configuration, it is possible to further reduce or prevent an excessive extrusion force from being applied to the extrusion pins 62 or the molded product PD compared to a case where the torque map TM in which the output torque becomes greater in the stepwise manner is used.

According to the diecasting machine 500 according to the present embodiment, the control device 90 drives the extrusion driving unit 80 to cause the extrusion pins 62 to operate using great extrusion forces in a case where the contact area of the mold 50 and the molding material is large compared to a case where the contact area is small. By using the torque map TM which takes into account the contact area of the mold 50 and the molding material which is a factor which influences the adhesion force of the molding material and the mold 50, it is possible to improve precision of the output torque of the extrusion driving unit 80 in the torque map TM.

The present disclosure is not limited to the embodiments described above and is able to be realized with various configurations without departing from the spirit thereof. For example, technical features in the embodiments are able to be replaced with each other or combined together as necessary in order to solve part or the whole of the problems described previously or to achieve part or the whole of the effects described previously. When the technical features are not described as essential features in the present specification, they are able to be deleted as necessary. For example, the present disclosure may be realized with embodiments which will be described below.

(1) One aspect of the present disclosure provides a molding machine. This molding machine includes: a mold that forms a molded product; an extrusion pin that transmits to the molded product an extrusion force for demolding the molded product from the mold, wherein the extrusion pin is inserted in the mold; and a control device configured to control the extrusion force of the extrusion pin; wherein the control device controls the extrusion force at a first timing elapsed a first elapsed period so as to be greater than the extrusion force at second timing elapsed a second elapsed period, wherein the first elapsed period is an elapsed period from a predetermined start point, wherein the second period is an elapsed period from the start point and a shorter than the first elapsed period.

In a case where the elapsed period from the start point is long, the molding machine according to this aspect makes the extrusion force for demolding the molded product great compared to a case where the elapsed period is short. Consequently, it is possible to make the extrusion force great so as to correlate with an adhesion force of the molded product which is applied to the mold and which increases as the elapsed period becomes longer. Consequently, it is possible to prevent or reduce an excessive extrusion force from being applied to the extrusion pins or the molded product compared to a molding machine which extrudes a molded product using a fixed extrusion force irrespectively of the elapsed period.

(2) In the molding machine according to the above aspect, the elapsed period may be a period from the start point set at or after a timing at which at least a molding material is injected in the mold to a timing at which the molded product is fixed to a convey device that takes out the molded product from the molding machine.

The molding machine according to this aspect can set an appropriate extrusion force for a variation of the adhesion force caused by a variation of a cooling period of the molded product which occurs due to an abnormality of the convey device.

(3) In the molding machine according to the above aspect, the start point may be a timing at which filling the molding material in the mold is finished.

The molding machine according to this aspect sets the point of time at which filling the molding material is finished as the start point of the elapsed period to make it easy for the control device to measure the time.

(4) In the molding machine according to the above aspect, as the elapsed period becomes longer, the control device may control the extrusion force so as to be greater in a stepwise manner.

By adjusting the extrusion force in the stepwise manner, the molding machine according to this aspect can reduce a processing burden of the control device compared to a case where the extrusion force is adjusted in a non-stepwise manner.

(5) In the molding machine according to the above aspect, the control device may include a map, the map indicates a relationship between the elapsed period and the extrusion force.

The molding machine according to this aspect can reduce the processing burden of the control device compared to a case where the extrusion force is determined by an arithmetic operation.

(6) In the molding machine according to the above aspect, when a contact area of the mold and the molding material is large, the control device may control the extrusion force so as to be greater than when the contact area is small.

According to the molding machine according to this aspect, by taking into account the contact area of the mold and the molding material which is a factor which influences the adhesion force of the molding material and the mold, it is possible to more precisely determine the extrusion force.

The present disclosure can be also realized as various aspects other than the molding machine. The present disclosure can be realized as aspects such as a molded product manufacturing method, a molding machine control method, a computer program which realizes this control method and a non-transitory recording medium having this computer program recorded thereon.

What is claimed is:

1. A molding machine comprising:
a mold that forms a molded product;
an extrusion pin that transmits to the molded product an extrusion force for demolding the molded product from the mold, wherein the extrusion pin is inserted in the mold; and
a control device configured to control the extrusion force of the extrusion pin;
wherein the control device controls the extrusion force at a first timing elapsed a first elapsed period so as to be greater than the extrusion force at second timing elapsed a second elapsed period, wherein the first elapsed period is an elapsed period from a predetermined start point, wherein the second period is an elapsed period from the start point and a shorter than the first elapsed period.

2. The molding machine according to claim 1,
wherein the elapsed period is a period from the start point set at or after a timing at which at least a molding material is injected in the mold to a timing at which the molded product is fixed to a convey device that takes out the molded product from the molding machine.

3. The molding machine according to claim 2,
wherein the start point is a timing at which filling the molding material in the mold is finished.

4. The molding machine according to claim 1,
wherein, as the elapsed period becomes longer, the control device controls the extrusion force so as to be greater in a stepwise manner.

5. The molding machine according to claim 1,
wherein the control device includes a map, the map indicates a relationship between the elapsed period and the extrusion force.

6. The molding machine according to claim 1,
wherein, when a contact area of the mold and the molding material is large, the control device controls the extrusion force so as to be greater than when the contact area is small.

7. A method for extruding a molded product comprising:
injecting in a mold a molding material for forming the molded product; and
transmitting to the molded product an extrusion force for demolding the molded product from the mold, wherein the extrusion force at a first timing elapsed a first elapsed period is greater than the extrusion force at second timing elapsed a second elapsed period, wherein the first elapsed period is an elapsed period from a predetermined start point, wherein the second period is an elapsed period from the start point and a shorter than the first elapsed period.
